(19) United States
(12) Patent Application Publication
(10) Pub. No.: US 2026/0289813 A1
(43) Pub. Date: Sep. 24, 2026

(54) SYSTEMS AND METHODS FOR DETECTING OBJECTS

(71) Applicant: Cognex Corporation, Natick, MA (US)

(72) Inventor: Philippe Hanhart, Vevey (CH)

(73) Assignee: Cognex Corporation, Natick, MA (US)

(21) Appl. No.: 19/472,393

(22) PCT Filed: Apr. 5, 2024
(86) PCT No.: PCT/US2024/023313

§ 371 Date: Oct. 3, 2025

Related U.S. Application Data
(60) Provisional application No. 63/457,715, filed on Apr. 6, 2023.

(51) Int. Cl. G06T 7/73; G06T 7/62; G06V 10/77

(52) U.S. Cl. CPC G06T 7/73; G06T 7/62; G06V 10/7715; G06V 2201/07

(57) ABSTRACT

The techniques described herein relate to computerized methods and apparatuses for detecting objects in an image. The techniques described herein further relate to computerized methods and apparatuses for detecting one or more objects using a machine learning model that can be trained to predict pose of an object using a plurality of feature vectors. The feature vectors may be extracted from a feature map of an image at locations that are arranged in a circular pattern.

### CROSS-REFERENCE TO RELATED APPLICATIONS

This application claims the benefit of priority under 35 U.S.C. 119 (e) to U.S. Provisional Patent Application Ser. No. 63/457,715, filed on Apr. 6, 2023, and titled “SYSTEMS AND METHOD FOR DETECTING OBJECTS,” which is incorporated by reference herein in its entirety.

### FIELD

This technology relates to machine vision systems and methods, and more particularly to systems and methods for detecting objects.

### BACKGROUND

It can be desirable to detect objects in an image for machine vision applications. Various techniques can be used to detect objects in an image. However, existing systems face challenges in accurately detecting location, orientation, and/or size of object(s) in the image, which can be important for achieving high performance in any subsequent machine vision applications.

### SUMMARY

The present disclosure relates to techniques for detecting objects in an image. Some aspects of the described techniques provide for a computerized method, a non-transitory computer-readable media and/or a system for detecting a pose of at least an object in an image, such as object location, orientation, and/or size. The method includes accessing a feature map of the image, wherein the feature map was generated using a pre-trained machine learning model and the image as input to the pre-trained machine learning model. In some embodiments, the feature map may include a plurality of samples that are each associated with a respective feature vector. The method may further include extracting a plurality of feature vectors from the feature map at respective locations on the feature map, wherein the respective locations are arranged around a circular pattern. The method may further include determining an orientation of the object in the image based on the plurality of feature vectors.

In some embodiments, a system is provided that include an image capturing device to obtain an image containing at least an object; and at least a processor configured to perform operations for detecting a pose of the object in the image, such as object location, orientation, and/or size. The operations may include: accessing a feature map of the image, wherein the feature map was generated using a pre-trained machine learning model and the image as input to the pre-trained machine learning model. In some embodiments, the feature map may include a plurality of samples that are each associated with a respective feature vector. The operations may further include extracting a plurality of feature vectors from the feature map at respective locations on the feature map, wherein the respective locations are arranged around a circular pattern. The operations may further include determining an orientation of the object in the image based on the plurality of feature vectors.

In some embodiments, a non-transitory computer readable medium is provided that contain program instructions that, when executed, cause at least a processor configured to perform operations for detecting a pose of at least an object in an image, such as object location, orientation, and/or size. The operations may include: accessing a feature map of the image, wherein the feature map was generated using a pre-trained machine learning model and the image as input to the pre-trained machine learning model. In some embodiments, the feature map may include a plurality of samples that are each associated with a respective feature vector. The operations may further include extracting a plurality of feature vectors from the feature map at respective locations on the feature map, wherein the respective locations are arranged around a circular pattern. The operations may further include determining an orientation of the object in the image based on the plurality of feature vectors.

It should be appreciated that all combinations of the foregoing concepts and additional concepts described in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

Additional embodiments of the disclosure, as well as features and advantages thereof, will become more apparent by reference to the description herein taken in conjunction with the accompanying drawings. The components in the figures are not necessarily to scale. Moreover, in the figures, like-referenced numerals designate corresponding parts throughout the different views.

FIG. 1 is a diagram of an example system for detecting objects, according to some embodiments of the technologies described herein.

FIG. 2 illustrates components of an example system for detecting objects, according to some embodiments of the technologies described herein.

FIG. 3A shows an example image of an object, according to some embodiments of the technologies described herein.

FIG. 3B shows an extracted object view of the object in FIG. 3A that is determined by performing object detection, according to some embodiments of the technologies described herein.

FIG. 4 is a flowchart of an illustrative process for detecting object(s) in an image, according to some embodiments of the technologies described herein.

FIG. 5 is a flowchart of an illustrative process for training a machine learning model to be used in detecting characters, according to some embodiments of the technologies described herein.

FIGS. 6A-6C illustrate variations of feature vectors each representing a respective orientation, according to some embodiments of the technologies described herein.

FIG. 7 shows an example of concatenated feature vectors extracted from an image, according to some embodiments of the technologies described herein.

FIG. 8A lists different concatenated feature vector sets each corresponding to a respective rotation angle, according to some embodiments of the technologies described herein.

FIG. 8B shows different concatenated feature vector sets represented in color codes, according to some embodiments of the technologies described herein.

FIG. 9A illustrates a set of feature vectors and a perturbation of the set of feature vectors in orientation and position, according to some embodiments of the technologies described herein.

FIGS. 9B-9E illustrate sets of feature vectors at different rotation offsets, according to some embodiments of the technologies described herein.

FIG. 10 illustrates concentric circular feature patterns with different sizes, according to some embodiments of the technologies described herein.

FIG. 11 shows an illustrative implementation of a computer system that may be used to perform any of the aspects of the techniques and embodiments disclosed herein, according to some embodiments of the technologies described herein.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the invention is thereby intended.

It can be desirable to detect objects, such as a machine part, in an image for various machine vision applications. Conventional systems may detect, for example, a machine part in an image. However, conventional systems are often unable to detect an accurate pose, including location, orientation, and/or size of an object in the image. Such inaccurate poses can be due to the system environment and/or limitations of system components. For example, images captured during a manufacturing process may be of low quality due to various conditions in which the images are captured. Examples of these various conditions may include, for example, motion of the parts to be captured in the scene, the distance between the camera and the parts, unknown or uncontrollable poses of the parts in the scene, and/or the lighting conditions of the parts in the scene. Such conditions may affect, for example, the contrast of the images. As another example, the variations in the location of the printed labels on a part may affect the location of the characters in the captured image. These various conditions and other conditions during the manufacturing process have created difficulties in applying such conventional technologies.

Some object detection systems use deep machine learning models and are designed to adapt to a particular application or the environment in which the application is run. However, these systems may not be practical for certain machine vision applications. For example, deep machine learning based systems may be computationally intensive for both training and deployment, and may not be readily adaptable to field applications where the machine learning models may need to be trained or re-trained by the users.

Accordingly, the inventors have developed techniques described herein to provide an object detection system that can accurately detect object's pose (e.g., location, orientation, and/or size) from an image. Described herein are systems, methods, and non-transitory computer readable medium that contain program instructions for accurately detecting the pose of an object in an image. The system may use a pre-trained machine learning model (e.g., a deep machine learning model) and other machine learning models (e.g., non-deep machine learning model(s)) to perform one or more detection operations (e.g., to detect location, orientation, size, etc.). The system may be configured to process an image and generate a feature map of the image using the pre-trained machine learning model. The image may be captured in a machine vision application system, e.g., via an image capturing device. The feature map may include a plurality of samples each encoding semantic information at a respective position in the image.

In some embodiments, the system may be configured to determine locations (e.g., centers) of one or more objects in the image. The system may be configured to extract a plurality of feature vectors from the feature map, where the extracted feature vectors are provided to a machine learning model for predicting the object orientation and/or size. In some embodiments, the locations of the plurality of feature vectors may be arranged in a pattern such that the plurality of feature vectors encodes a respective orientation (e.g., an angle) of an object. The inventors have appreciated that it can be beneficial to extract feature vectors from the feature map based on a geometric pattern, such as a circular pattern. In some examples, the plurality of feature vectors may be extracted at respective locations on the feature map, wherein the respective locations are arranged around a circular pattern centered about the location of the object (e.g., the center of the object). The plurality of extracted feature vectors may be concatenated into a single feature vector, where different orders of the feature vectors are associated with different orientations. In some embodiments, the machine learning model may be trained with training images from which feature maps are generated and a plurality of training feature vectors are extracted from each feature map. The training feature vectors are associated with known orientations (e.g., rotation angles). Accordingly, a single set of feature vectors (that are extracted at respective locations of the feature map around a circular pattern) can be concatenated in different orders to train multiple orientations of a known object using just a single image. Accordingly, the techniques can use the concatenated feature vectors to train multiple orientations without needing to perform computationally-expensive operations, such as rotating the object and/or the image in order to train the multiple orientations. Once trained, the machine learning model may be used to predict object orientation (e.g., rotation).

In some embodiments, the system may be configured to use rotation offsets when determining the rotation of the object to accurately determine the object's rotation. The rotation offset may be a value smaller than the interval between two adjacent discrete rotation angles that may be detected by the machine learning model. In determining the rotation offset, a plurality of feature vector sets may be extracted from the feature map of the image at respective locations that are arranged in a circular pattern centered at the location of the object, where each feature vector set correspond to a respective one of a plurality of rotation offsets. The plurality of feature vector sets may be provided as input to the machine learning model to generate a plurality of predicted rotation offsets each with a classification probability. The rotation offset that maximizes the classification probability may be determined as the predicted rotation offset. The final orientation angle may be computed as the sum of the rotation offset and rotation angle predicted by the machine learning model. As a result, offsets can be used to fine-tune an initial rotation determination.

In some embodiments, the system may be configured to determine a size of the object in the image. The size of the object can be determined based on a plurality of feature sets that are each associated with a respective one of a plurality of circular pattern sizes. Each feature set can be extracted in a similar manner as described above with respect to extracting the feature vectors for predicting the object orientation. The system may use a machine learning model, which may be configured for a plurality of configurations that are each trained with a respective circular pattern size. As such, multiple concentric circular feature patterns may be used to extract different feature sets from the feature map of the image. The different feature sets may be provided to the plurality of configurations of the machine learning model to generate multiple outputs. The object size may be predicted based on the multiple outputs from the plurality of configurations of the machine learning model.

In some embodiments, the system may be configured to determine a category of an object in the image. In some embodiments, the system may use a machine learning model that is trained to predict the object category. Determining the object category may enable the system to be trained to detect objects belonging to a given object category, and enable object category specific feature vectors to be extracted. Additionally, and/or alternatively, an object category specific machine learning model (or a configuration thereof) may be trained for a given object category and used to predict object pose for the given object category. Thus, using object category specific feature vectors and object category specific machine learning model enables the system to achieve better performance for a given object category.

In some embodiments, the system may be configured to refine the detected object location, orientation, and/or size and generate final object location, orientation, and/or size.

In some embodiments, the system may be configured to extract an object view from the image based on the detected (or final) object location, orientation, and/or size. The extracted object view may include the detected object properly centered in the object view according to the final object location, with the orientation angle of the object properly corrected (e.g., de-skewed) according to the detected orientation (e.g., orientation angle and offset), and/or the size of the object properly scaled according to the detected size of the object. In some embodiments, the system may be configured to perform one or more machine vision applications on the extracted object view image.

In some embodiments, the system may be configured to train one or more machine learning models, such as the machine learning model for detecting object category and/or the machine learning model for detecting pose. For example, as described above, feature vectors can be extracted along a circular pattern and concatenated into a single feature vector, where different orders of the feature vectors can reflect different orientations of the object. As a result, a single training image (or a few training images, such as (a) two, three four, etc. training images, or (a) less than five training images, less than ten training images, etc.) can easily be used to train multiple different orientations of an object by simply reordering the order of the concatenated feature vectors. As a result, the techniques can use a single (or few) training image to train multiple orientations of an object without needing to perform computationally-expensive operations (e.g., rotating the object and/or the image). As another example, slight perturbations in object position and/or object orientation and/or object size may be used to generate various training examples from a single image or from a few images. Slight perturbations in object position, orientation and/or object size may be used to make the classifier prediction more robust.

Accordingly, the techniques described herein may provide various advantages over conventional systems that improve the performance of object detection. The techniques can provide for accurately detecting an object's location, orientation, and/or size, which can increase the accuracy and/or reliability of machine vision applications. Further, the use of geometric patterns, such as circular patterns, to extract feature vectors as input to the machine learning model makes the system more robust both in terms of training and execution, as discussed above and further below. In addition, as described in the present disclosure, training can be performed efficiently because the training data can be generated, modified, or re-used without requiring a significant collection of training images and/or large computational resources.

Whereas various embodiments have been described, it will be apparent to those of ordinary skill in the art that many more embodiments and implementations are possible. Accordingly, the embodiments described herein are examples, not the only possible embodiments and implementations. Furthermore, the advantages described above are not necessarily the only advantages, and it is not necessarily expected that all of the described advantages will be achieved with every embodiment.

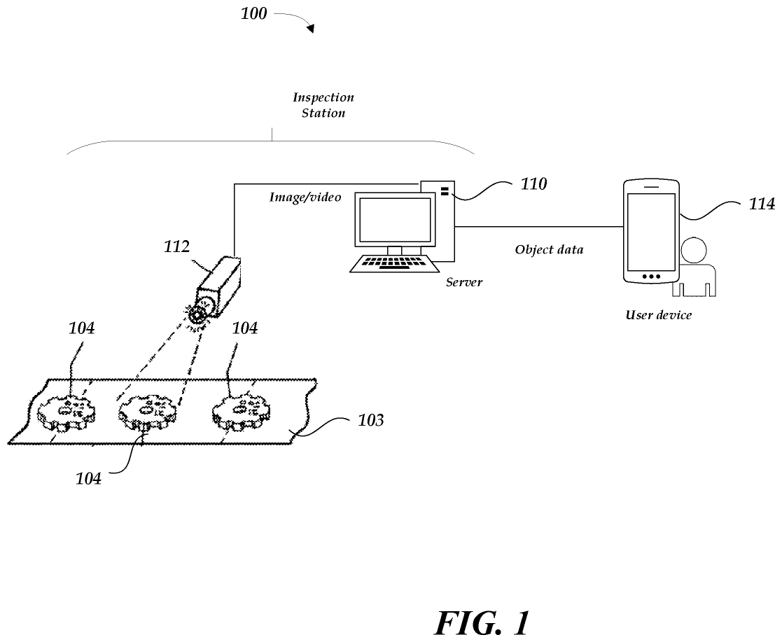

FIG. 1 is a diagram of an example system for detecting objects, according to some embodiments of the technologies described herein. In some embodiments, a system 100 may include an image capturing device 112, such as a camera, which is configured to capture a video or an image of a part 104 or any component on an inspection platform 103. A captured video may include a sequence of frame images, and each image may contain one or more parts 104 on the inspection platform 103. The system 100 may further include a server 110 having at least a processor, a memory, a storage medium, and/or other components. The at least one processor may be configured to execute programming instructions stored in the memory to analyze the images and perform object detection on each of the images to detect one or more objects in the images.

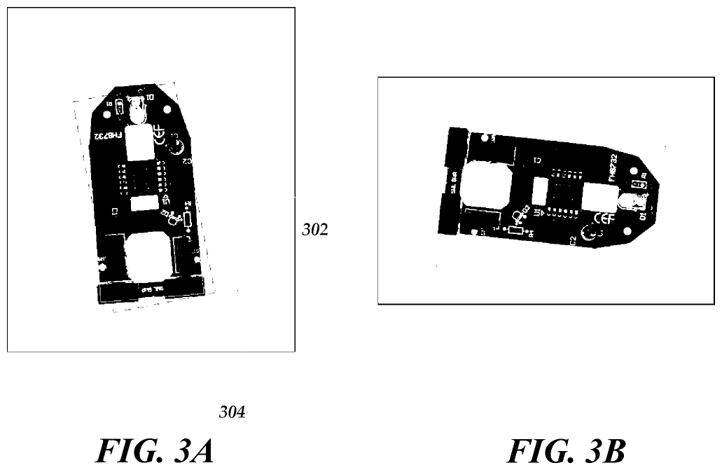

Various objects can be processed according to the techniques described herein. For example, FIG. 3A shows an example image of an object, e.g., a printed circuit board, according to some embodiments of the technologies described herein. As shown in FIG. 3A, the location of the object in the image may be off-centered. The object may also be rotated in the image. Further, the scale of the object may also vary. While some examples herein are described in conjunction with printed circuit boards, it should be appreciated that the techniques described herein can process various types of objects in an image. Other exemplary objects include any suitable part or object, such as a machine part, a document, a photo region in a document, a text region in a document, a character, a region having certain characteristics in an image (e.g., a building, a window, or any object in a scene in an image), and/or the like.

Returning to FIG. 1, the server 110 may be configured to process a captured image of one or more parts in real-time during an inspection process. In a non-limiting configuration, the part 104 may be placed on the inspection platform 103. For example, the inspection platform 103 may be a conveyor belt of an assembly line or a turntable on which multiple parts to be inspected are placed. The inspection platform 103 may be controlled to move the parts. Each time the inspection platform 103 moves a part (e.g., part 104) into a location for inspection, the part on the inspection platform 103 is captured by the image capturing device 112 such that the system 100 may process the captured image to detect the object. The server may repeat object detection for each image being captured. While the example in FIG. 1 and FIG. 3A only show one part 104 per captured image, it should be appreciated that multiple parts can be contained in a captured image, as desired.

With further reference to FIG. 1, once one or more objects in an image are detected, the server 110 may generate object data based on the detected object(s) and transmit the object data to an electronic user device associated with a user (114). The object data may include locations, orientations, and/or sizes (or a scaling factor) of one or more objects in the image. In other embodiments, the object data may include an object view image based on the captured image. For example, the object view image may be segmented from the captured image, with the detected object being centered in the segmented image. In some examples, the detected object may be rotated in the object view image, based on the detected rotation, such that the object is straight. In some examples, the detected object may be scaled in the object view image, based on the detected scaling factor, such that the object size is normalized.

In some embodiments, user device 114 may perform any suitable machine vision operations on the extracted object image. For example, the machine vision operations may include recognizing text in the image (e.g., optical character recognition), reading a barcode in the image, detecting defect of a part in the image, or any other suitable machine vision operations. Alternatively, and/or additionally, certain machine vision operations may be performed at server 110, where the server 110 may transmit the result of the machine vision operations to the user device 114. For example, server 110 may perform barcode reading on an image with a barcode, and transmit the information encoded in the barcode to the user device 114. Alternatively, user device 114 may be configured as a barcode reader. The user device 114 may receive an object image (e.g., barcode image) with a barcode label from server 110, and decode the barcode in the object image.

In a non-limiting example, the one or more objects in an image may include one or more printed textual characters on a part contained in the image. Thus, system 100 may be configured to recognize the one or more textual characters on the part and track the part using at least one recognized textual character. In some embodiments, system 100 may be implemented in a barcode scanner, of which an image capturing device (e.g., 112) may be configured to capture an image containing parts having the labels printed thereon. System 100 may be configured to process the captured image by detecting the location of the barcode and decode the located barcode. Various arrangement of components in system 100 may be configured to enable a particular application. For example, user device 114 may be configured to be a barcode (e.g., 1D or 2D) scanner. User device 114 may include an image capturing device 112 (e.g., a phone camera) to capture an image of a part having a barcode thereon. The user device may be configured as a barcode scanner to detect a location of a barcode (e.g., 1D or 2D barcode) in the captured image and decode the barcode in the image based on detected location of the barcode. Various other applications may also be implemented in system 100.

In some embodiments, the techniques described herein may use the detected object position, orientation, and/or size information for object fixturing and/or for any other suitable application that will benefit from object pose detection. Referring to FIG. 1, because the part 104 on an inspection platform 103 may be in different location and/or orientation each time the image capturing device 112 is triggered and part 104 may also vary in size, the object in the captured image may vary in location, orientation, and/or size. A machine vision application may perform object fixturing so that the part is centered, de-skewed, and/or scaled in the image and/or sequence of frame images, which may then be analyzed by one or more processes of the machine vision application. Examples of such processes may include reading a sequence of characters in a specific area, reading a barcode in a specific area, defect detection (e.g., detecting defect(s) in a part to be inspected), assembly verification (e.g., verifying that all part components may be present at a proper location and/or with a proper orientation), processing of any specific area of a part, or any other task that may be required by the application.

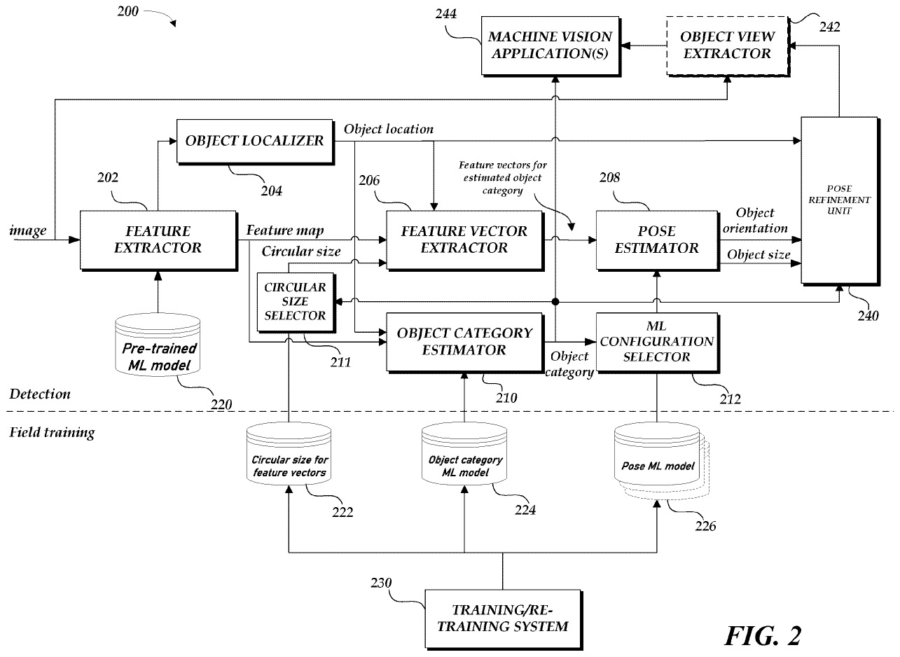

In FIG. 1, although server 110 and user device 114 are shown to perform the object detection and subsequent machine vision applications, it is appreciated that a single computing device (e.g., at the server or the user device) may be configured to perform the detecting/training operations. In some variations, detection operation and field training, as will be described with respect to FIG. 2, may be implemented on a single computer device with low computing power or storage (e.g., a user device, such as a smart phone, or an embedded system, such as a smart camera) because various components and processes as described in the present disclosure do not require extensive computing resources. For example, the various machine learning models can be implemented with non-deep learning models and thus can be field trained using lower computing power devices than otherwise required for deep learning models. In other variations, the embodiments described herein may also be implemented in multiple computing devices in a distributed system.

FIG. 2 illustrates components of an example system 200 for detecting objects, according to some embodiments of the technologies described herein. System 200 may include one or more blocks that may be implemented in the system 100, such as server 110 (FIG. 1). In some embodiments, system 200 may include one or more blocks configured to detect object(s) from an image using machine learning models. System 200 may also include one or more blocks configured to train one or more machine learning models used in detecting objects. As shown in FIG. 2, system 200 may be configured to operate in detection mode and training mode, referred to herein for exemplary purposes only as a field training mode. For example, in the detection mode, the system 200 may use a pre-trained machine learning model 220 and other machine learning models (e.g., object category ML model 224, pose ML model 226) to perform one or more detection operations (e.g., detecting location, orientation, size, etc.). Additionally, in the field training mode, the system 200 may be configured to train the other machine learning models (e.g., object category ML model 224, pose ML model 226) in one or more field training processes, including as discussed herein.

A pre-trained machine learning model may be a machine learning model that is trained at a time prior to the machine learning model being deployed and used (e.g., at a site, such as in a customer application). The pre-trained machine learning model may be trained at a site that is the same as, or different from, where the machine learning model is deployed in the field application. In some embodiments, once deployed, the pre-trained machine learning model may not be modified. In some embodiments, some types of machine learning models (e.g., object category ML model 224, pose ML model 226) may be trained in a field training process. These machine learning models may be trained at a same and/or different site different from where the pre-trained machine learning model is trained, at a time after when the pre-trained machine learning model is trained, and/or in a stage different than a stage in which the pre-trained machine learning model is trained. In a non-limiting example, the pre-trained machine learning model (e.g., 220) may be trained in a development/design stage prior to the system 200 being deployed. Other machine learning models (e.g., object category ML model 224, pose ML model 226) may be trained in a deployment stage while the system 200 is being deployed. For example, the deployment stage may include a field training mode, as previously described, in which the machine learning models may be trained in a field training process.

In deploying system 200, the pre-trained machine learning model 220 may be used in combination with other machine learning models (e.g., object category ML model 224, pose ML model 226) that can be customarily trained by the user. For example, the user may collect application specific training data and use a training system 230 to train the other machine learning models (e.g., object category ML model 224, pose ML model 226). As discussed further herein, just one image (or a few images, such as two, three four, etc. images) can be used to train the other machine learning models (e.g., in a field training process). For example, a single training image or a few training images can be used to train multiple different orientations of an object by extracting feature vectors that are indicative of the objects orientation and storing the feature vectors in a manner that allows the features vectors to be reordered, in a non-computationally expensive manner, so that the feature vectors reflect different orientations of the object. As a result, the techniques can use a single or few training images to train multiple orientations of an object without needing to perform computationally-expensive operations (e.g., rotating the object and/or the image). As another example, slight perturbations in object position and/or object orientation and/or object size may be used to generate various training examples from a single image or from a few images. System 200 is now described further in detail.

In some embodiments of the techniques described herein, system 200 may include a feature extractor 202 configured to process an image and generate a feature map of the image using a pre-trained machine learning model 220. The image as input to the feature extractor may include an image captured in system 100 (e.g., via image capturing device 112 in FIG. 1). The pre-trained machine learning model may be a deep machine learning model that is trained to process an input image and output a feature map of the image. In some examples, the pre-trained machine learning model may be trained from a training dataset including a plurality of images containing one or more objects. The other machine learning models (e.g., object category ML model 224, pose ML model 226) may be trained using different training datasets, such as custom datasets that include images captured from applications in a particular domain, such as the image shown in FIG. 3A.

In some embodiments, the feature map, as output of the pre-trained machine learning model may include a plurality of samples each including a vector (feature vector) having multiple values that encode semantic information at each respective position in the image. For example, the feature map may have a tensor of shape h×w×D, where h is the height of the feature map, w is the width of the feature map, and D is the number of channels of the feature map. The pre-trained machine learning model 220 may be configured to encode some features of the image for subsequent processing. In some examples, the pre-trained machine learning network may include a feature pyramid network and an up-sampling-and-concatenation network. The feature pyramid network may be a neural network that takes an image as input and outputs one or more feature maps that are generated independently, for example, at different scales. In a non-limiting example, the feature pyramid network may generate multiple feature maps of different sizes, e.g., h1×w1×D1, h2×w2×D2, and h3×w3×D3. Various implementations of a feature pyramid network may be available. For example, feature pyramid networks as described in Lin et al., “Feature Pyramid Networks for Object Detection,” December, 2016, (arxiv.org/abs/1612.03144), may be used, and herein incorporated by reference in its entirety.

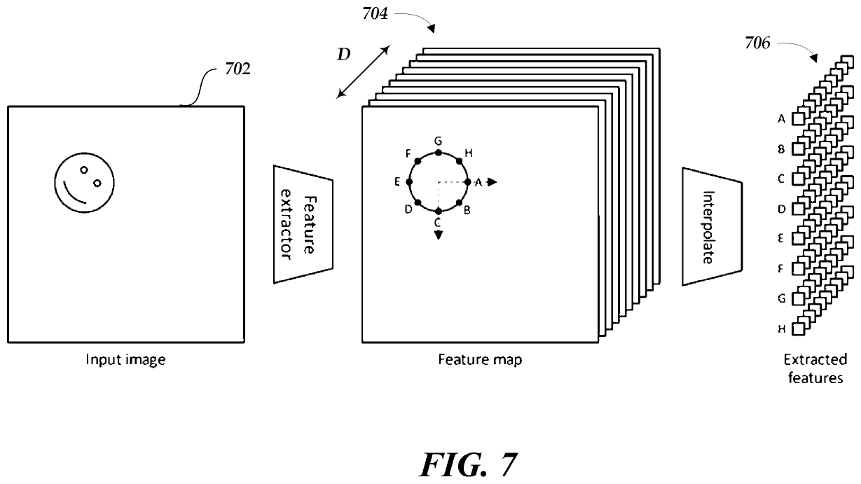

In some embodiments, the up-sampling-and-concatenation network in the pre-trained machine learning network may be configured to take each feature map and up-sample it (e.g., using a bi-linear interpolation) to a common size h×w. As such, the multiple feature maps may be respectively converted to feature maps of sizes: h×w×D1, h×w×D2, and h×w×D3. These feature maps may be concatenated to generate the output feature map of size h×w×D. In some examples, the number of channels D in the output feature map may have a value D=D1+D2+D3. FIG. 7 shows an example of concatenated feature vectors extracted from an image, according to some embodiments of the technologies described herein. As shown, image feature map 704 is a tensor having a dimension of h×w×D, where the feature map has h×w samples, each associated with a feature vector having D elements.

In a non-limiting example, the feature map may have a different size than that of the image. For example, h and w may take the values of H/8 and W/8, respectively, or other suitable values, where H and W are the size of the image. The width and height of an image may not be equal, nor are the width and height of a feature map. For example, h may have a value of 16, and w may have a value of 24. Any other suitable values may be possible for h and w. In a non-limiting example, the number of channels D may have a value of 128, or other suitable values. When the pre-trained machine learning network is a deep CNN, the CNN may be configured to include a feature pyramid network by selecting some layers in the CNN and using their activations as output. Such pre-trained machine learning network may be deployed in an application in various domains without needing to be retrained.

Returning to FIG. 2, system 200 may include an object localizer 204 configured to determine locations of one or more objects in the image. In some embodiments, the system may determine the center of the object(s) based on the feature map obtained from feature extractor 202. In some embodiments, samples near a center of an object in an image may have higher values in an object center heatmap than samples in other areas in the image. An object center heatmap may include a plurality of samples each having a value indicative of a likelihood of a corresponding sample in the image being a center of an object. The object center heatmap may be generated by processing the feature map of the image (e.g., using a machine learning model). As such, object localizer 204 may determine the locations of the one or more objects in an image based on the values of corresponding samples of the object center heatmap. For example, a list of positions in the image may be selected as object centers by filtering out the positions whose values of corresponding samples in the object center heatmap are below a threshold value. An example of an object localizer can include, for example, the object localizer discussed in U.S. patent application Ser. No. 17/961,711, entitled “Systems and Methods for Detecting Objects,” which is incorporated herein by reference in its entirety.

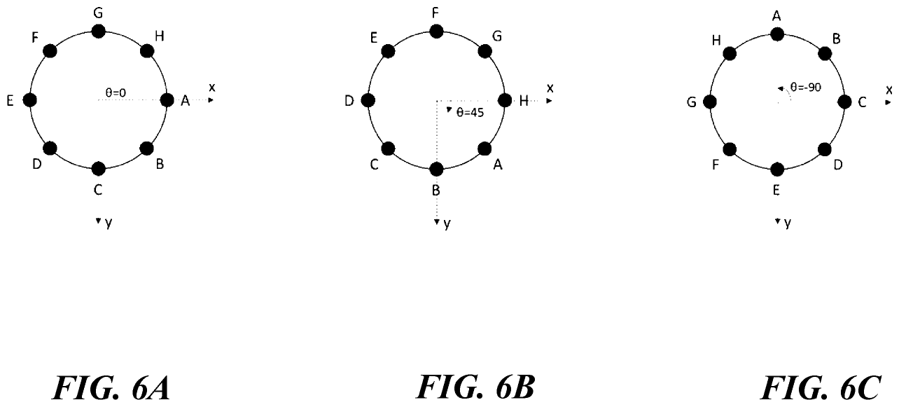

With further reference to FIG. 2, system 200 may include a feature vector extractor 206 configured to extract a plurality of feature vectors from the feature map, where the extracted feature vectors are provided to a machine learning model for predicting the object pose, including orientation and/or size. In some embodiments, the locations of the plurality of feature vectors may be arranged in a pattern such that the plurality of feature vectors encodes a respective orientation (e.g., an angle) of an object. FIGS. 6A-6C illustrate variations of feature vectors each representing a respective orientation, according to some embodiments of the technologies described herein. As shown in FIGS. 6A-6C, in some embodiments, the plurality of feature vectors may be extracted at respective locations on the feature map, wherein the respective locations are arranged around a circular pattern centered about the location of the object (e.g., the center of the object), which may be obtained in object localizer 204 (FIG. 2). Returning to FIG. 2, the circular pattern used to extract the feature vectors may have a size (e.g., radius) that may be stored in 222. In some examples, the size of the circular pattern may be determined empirically or obtained from a training process. In some embodiments, system 200 may store in 222 a plurality of circular pattern sizes that are each associated with a respective one of a plurality of object categories.

With further reference to FIG. 2, system 200 may further include a pose estimator 208 configured to determine an orientation of the object in the image based on the plurality of feature vectors from the feature vector extractor 206. In some embodiments, determining the orientation of the object may include using a machine learning model (e.g., pose ML model 226) and the plurality of feature vectors as input to the machine learning model, where the machine learning model is trained to determine the orientation angle of the object in the image. In some embodiments, the plurality of feature vectors may be concatenated into a single feature vector and provided as input to the machine learning model.

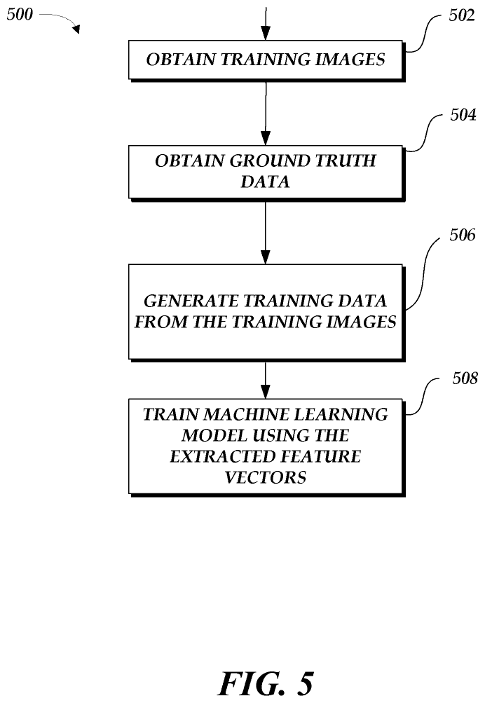

In some embodiments, the pose estimator 208 may also be configured to determine a rotation offset of the object. The rotation offset may be a value smaller than the interval between two adjacent discrete rotation angles that may be detected by the machine learning model (e.g., pose ML model 226). In some embodiments, the machine learning model (e.g., pose ML model 226) may be trained to predict the rotation offset, the process of which is further described in detail in embodiments of FIG. 5. In determining the rotation offset, a plurality of feature vector sets may be extracted from the feature map of the image at respective locations that are arranged in a circular pattern centered at the location of the object, where each feature vector set correspond to a respective one of a plurality of rotation offsets. The plurality of feature vector sets may be provided as input to the trained machine learning model (e.g., pose ML model 226) to generate a plurality of predicted rotation offsets each with a classification probability. The rotation offset that maximizes the classification probability may be determined as the predicted rotation offset. The final orientation angle may be computed as the sum of the rotation offset and rotation angle predicted by the machine learning model (e.g., pose ML model 226).

In some embodiments, the pose estimator 208 may also be configured to determine object size in the image based on the plurality of feature vectors obtained from feature vector extractor 206. In some embodiments, determining the size of the object may include using a machine learning model (e.g., pose ML model 226) which may be configured for a plurality of configurations, each trained with a respective circular pattern size. The plurality of feature sets may be extracted from the image such that they are each associated with a respective one of a plurality of circular pattern sizes. For example, each of the plurality of feature sets may be extracted from the feature map according to a circular pattern having a respective one of the plurality of circular pattern sizes. As such, multiple concentric circular feature patterns may be used to extract different feature sets from the feature map of the image. The different feature sets may be provided to the plurality of configurations of the machine learning model to generate multiple outputs. The pose estimator 208 may be configured to predict the object size based on the multiple outputs from the plurality of configurations of the machine learning model.

In some embodiments, system 200 may further include an object category estimator 210 configured to determine an object category from the image. In some embodiments, the object category estimator 210 may use a machine learning model (e.g., object category ML model 224 in FIG. 2) that is trained to predict the object category. Determining the object category may enable the system to be trained to detect objects belonging to a given object category, and enable object category specific feature vectors to be extracted. Additionally, and/or alternatively, an object category specific machine learning model (or a configuration thereof) may be trained for a given object category and used to predict object pose for the given object category. Thus, using object category specific feature vectors and an object category specific machine learning model enables the system to achieve better performance for a given object category. As shown in FIG. 2, the predicted object category from object category estimator 210 may be provided to various blocks, such as circular size selector 211, pose refinement unit 240, ML configuration selector 212, and/or machine vision application 244, each of which may be performed based on the detected category.

In some embodiments, system 200 may include a circular size selector 211 configured to select a corresponding circular size from a plurality of circular sizes (e.g., circular size for feature vectors 222). The selected circular size may be used by the feature vector extractor 206 to scale the circular pattern for the detected object category. In some embodiments, system 200 may include a machine learning configuration selector 212 configured to select a corresponding machine learning configuration of a plurality of configurations of the machine learning model (e.g., pose ML model 226) that is trained for the detected object category. Once the object category is detected from object category estimator 210, feature vectors for the estimated object category may also be extracted from feature vector extractor 206 and provided to the pose estimator 208.

With further reference to FIG. 2, system 200 may further include a pose refinement unit 240 configured to refine the detected object location, orientation, and/or size and generate final object location, orientation, and/or size. In some embodiments, system 200 may optionally include an object view extractor 242 configured to extract an object view from the image based on the detected (or final) object location, orientation, and/or size. The extracted object view may include the detected object centered in the object view according to the final object location, with (a) the orientation angle of the object corrected (e.g., de-skewed) according to the detected orientation (e.g., orientation angle and offset), and/or (b) the size of the object scaled according to the detected size of the object. In some embodiments, system 200 may further include one or more machine vision applications 244 configured to perform machine vision applications on the extracted object view image and associated object category.

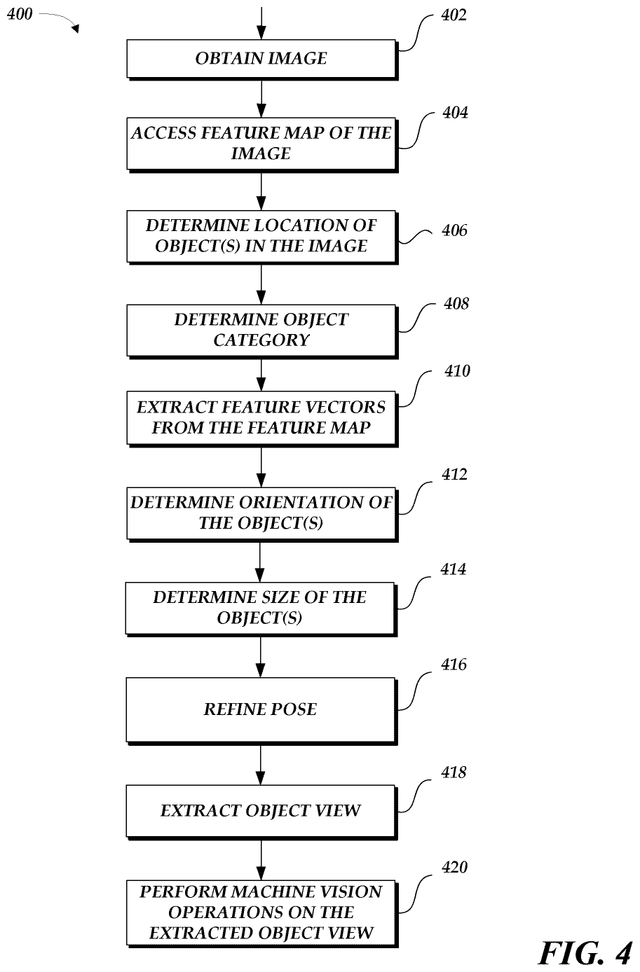

In some embodiments, system 200 may further include a training/re-training system 230 configured to train one or more machine learning models, such as object category machine learning model 224, pose machine learning model 226. The training/re-training system 230 may also determine the circular size 222 through training. Details of the training process(es) are further described in conjunction with FIGS. 4 and 5.

FIG. 3B shows an extracted object view of the object in FIG. 3A determined by performing an object detection process as described herein (e.g., including in conjunction with system 200), according to some embodiments of the technologies described herein. For example, bounding box 304 is overlaid on the original image (FIG. 3A), where bounding box 304 is determined based on the predicted object location, orientation, and size in system 200. The image in FIG. 3B is extracted from the original image with the object centered, oriented, and scaled based on the bounding box 304. Details of operations of various blocks in system 200 are further described with reference to FIGS. 4-10.

FIG. 4 is a flowchart of an illustrative process 400 for detecting object(s) in an image, according to some embodiments of the technologies described herein. In some embodiments, process 400 may include a method that is implemented in a system, such as system 100 (FIG. 1) and/or system 200 (FIG. 2). Method 400 may start with obtaining an image (of one or more objects), at act 402. For example, the image may be obtained from an image capturing device (e.g., 112 in FIG. 1). Method 400 may further include accessing a feature map of the image, at act 404, where the feature map may include a plurality of samples that are each associated with a respective feature vector (see 704 in FIG. 7). As described in embodiments in FIG. 2, the feature map of the image may be generated using a feature extractor (e.g., 202 in FIG. 2). For example, the feature map may be generated using a pre-trained machine learning model (e.g., 220 in FIG. 2) and the image as input to the pre-trained machine learning model.

With further reference to FIG. 4, method 400 may include extracting a plurality of feature vectors from the feature map, at act 410, determining the orientation of the object in the image based on the plurality of feature vectors, at act 412, and determining the size of the object in the image based on the plurality of feature vectors, at act 414. In some examples, act 410 may be implemented in a feature vector extractor (e.g., 206 in FIG. 2). Acts 412, 414 may be implemented in a pose estimator (e.g., 208 in FIG. 2).

In some embodiments, method 400 may optionally include determining the location of the object(s) in the image, at act 406. In some embodiments, act 406 may be performed in an object localizer (e.g., 204 in FIG. 2) which is described above in embodiments in FIG. 2. For example, act 406 may be performed using a heatmap as described in embodiments in block 204 of FIG. 2. It is appreciated that other suitable algorithms for detecting a center of the object in an image may be used. It is further appreciated that act 406 may be optional. For example, if an object is already centered in the image, the location of the object may be determined by the center of the image, and act 406 will not be needed. As another example, data may be provided that already indicates the object location.

Returning to act 410, in some embodiments, the locations of the plurality of feature vectors can be equally spaced and arranged around the circular pattern. The circular pattern may be used to extract feature vectors in the feature map. In the examples in FIGS. 6A-6C, eight feature vectors A-H are arranged at respective eight equally spaced positions arranged around a circle. The order of the feature vectors represents a respective orientation (angle). For example, as shown in FIG. 6A, the feature vectors are ordered in a clockwise fashion starting from the x-axis. Thus, the plurality of feature vectors arranged in ABCDEFGH represents a zero-degree rotation. As shown in FIG. 6B, the feature vectors arranged in the order of HABCDEFG represents a clockwise 45-degree rotation. As shown in FIG. 6C, the feature vectors arranged in the order of CDEFGHAB represents a counter clockwise 90-degree rotation.

In some embodiments, the plurality of feature vectors may be concatenated and stored as a concatenated set of feature vectors in an order that is based on the circular pattern. FIG. 7 shows an example of concatenated feature vectors 706 extracted from an image, according to some embodiments of the technologies described herein. As shown, each of the plurality of feature vectors 706 is extracted from the feature map 704 at a respective location as described above and further herein. As shown in FIG. 7, the plurality of feature vectors are arranged in the order from A to H.

Returning to FIGS. 6A-6C, the number of feature vectors (e.g., 8) may be concatenated to form a single feature vector that encodes orientation information. The concatenated feature vector may be of size F·C_{f}, where F is the number of feature vectors and C_{f} is the size of each feature vector (e.g., the number of channels in the feature map). The F feature vectors may be concatenated in a specific order, in clockwise or counterclockwise, to preserve the spatial arrangement of the individual features. The F features may be concatenated starting from a specific position, e.g., starting from the feature closest to θ=0, where θ is the angle in a polar coordinate system centered with the circular pattern. In the examples above in FIGS. 6A-6C, the eight feature vectors may be concatenated as ABCDEFGH, HABCDEFG, and CDEFGHAB, respectively. The concatenated feature vector may be used to predict the orientation of the object as described above and further herein.

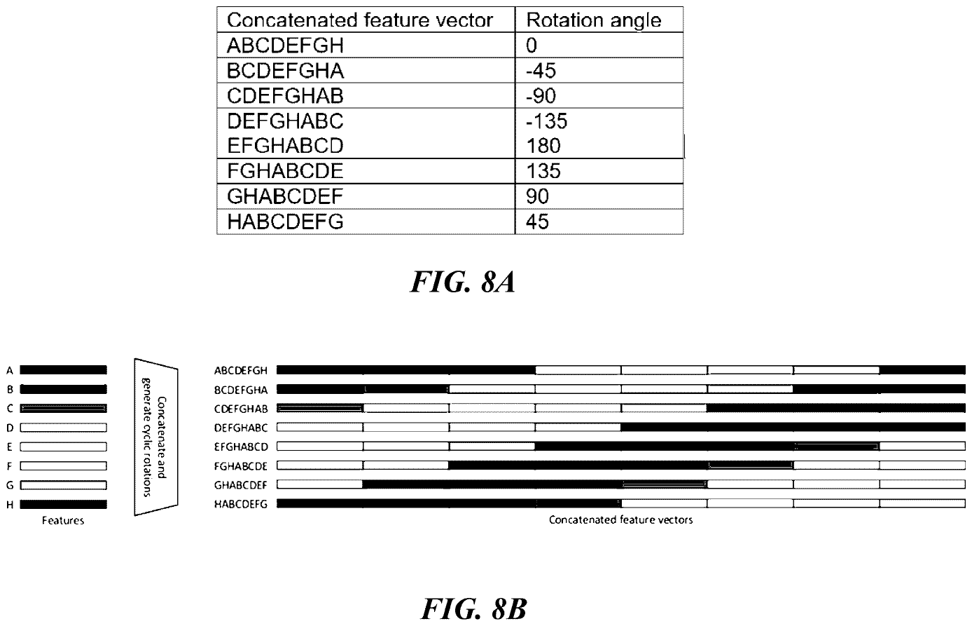

FIG. 8A lists different concatenated feature vector sets each corresponding to a respective rotation angle, according to some embodiments of the technologies described herein. In FIG. 8A, a positive angle represents a clockwise rotation; wherein a negative angle represents a counter clockwise rotation. FIG. 8B shows different concatenated feature vector sets represented in color codes, according to some embodiments of the technologies described herein.

In some embodiments, the circular pattern may be centered on the object center and the feature vectors may be extracted from the feature map by interpolating the feature map at respective locations for the feature vectors. Different interpolation methods such as nearest neighbor, bilinear, bicubic, and/or any other interpolation method may be used to interpolate the feature map. FIG. 7 shows how the features may be extracted from the feature map using the circular feature pattern for F=8.

Returning to FIG. 4, act 412 may determine an orientation of the object in the image based on the plurality of feature vectors obtained from act 410. In some embodiments, determining the orientation of the object may include using a machine learning model (e.g., pose ML model 226 in FIG. 2) and the plurality of feature vectors as input to the machine learning model to determine the orientation of the object in the image. In some embodiments, the plurality of feature vectors may be concatenated into a single feature vector and provided as input to the machine learning model.

In some embodiments, the machine learning model may be a classifier trained to predict a rotation angle based on the concatenated feature vector. The classifier may predict a probability score associated with the predicted rotation angle. In some embodiments, a classifier such as a linear classifier, Support Vector Machine (SVM), random forest, and/or any other suitable classifier may be trained to predict the rotation angle. The training of the machine learning model is described further in detail with reference to FIG. 5.

In some embodiments, the probability scores may be computed from the classifier distance, e.g., using a softmax function with temperature scaling and/or any other suitable method. In some embodiments, in the above example (e.g., FIG. 8A), with eight variations of concatenation of feature vectors, eight discrete rotation angles may be obtained from the classifier. In some embodiments, the discrete rotation angles and associated probability scores that are obtained from the classifier may be interpolated to estimate a finer rotation angle and/or probability score. In some embodiments, the rotation angle and/or probability score may be interpolated using a weighted sum where the probability scores may act as weights. The rotation angle and/or probability score may be interpolated using linear interpolation, quadratic interpolation, cubic interpolation, and/or any other interpolation method.

With reference to FIG. 4, act 412 may include determining a rotation offset of the object. The rotation offset may be a value smaller than the interval between two adjacent discrete rotation angles. Thus, the predicted angle may be the sum of the predicted rotation angle and the rotation offset. In the above example, where there are eight discrete angles spaced at 360/8=45 degrees interval around a circle, a rotation offset has a value between zero and 45 degrees.

In some embodiments, the machine learning model (e.g., pose ML model 226 in FIG. 2) may be trained to predict the rotation offset, the process of which is further described in detail in embodiments of FIG. 5. In determining the rotation offset, a plurality of feature vector sets may be extracted from the feature map of the image at respective locations that are arranged in a circle pattern centered at the location of the object, each feature vector set corresponding to a respective one of a plurality of rotation offsets. The rotation offsets may be smaller than the angle between two feature vectors.

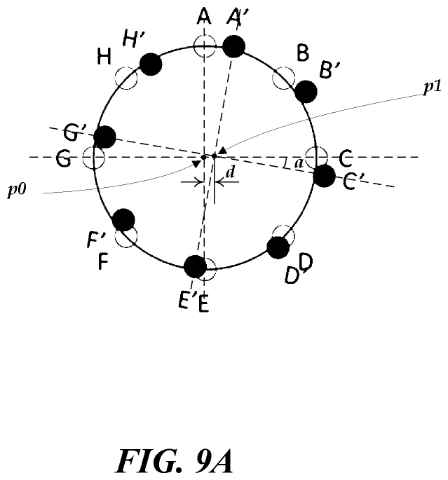

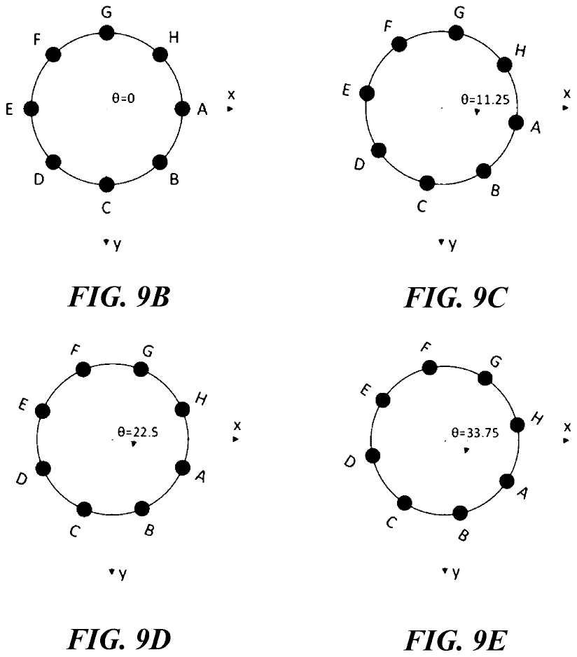

In a non-limiting example, act 410 (FIG. 4) may include extracting a plurality of feature vector sets respectively at rotation offsets

$${o}_{k} = k \frac{360}{F \cdot N}$$

where k∈{0, . . . , N−1} and N≥1 may be the number of rotation offsets, and F is the number of discrete angles for rotation angle detection as described above and further herein. FIGS. 9B-9E illustrate sets of feature vectors at different rotation offsets, according to some embodiments of the technologies described herein. In the above example, F=8 and N=4, and thus, for each rotation offset, a respective feature vector set is extracted using the circular pattern and concatenated in a similar manner as described above (see FIGS. 8A and 8B). For each concatenated feature vector, the rotation angle and corresponding classification probability may be predicted from the trained rotation angle classifier (e.g., pose ML model 226 in FIG. 2). The rotation offset that maximizes the classification probability may be determined as the predicted rotation offset. The final orientation angle may be computed as the sum of the rotation offset and rotation angle predicted by the classifier.

In various embodiments described with respect to act 410, the various feature vectors may be extracted according to positions based on the object center, which may be detected, for example, using the feature map of the image. The circular pattern used to extract the feature vectors may have a size (e.g., radius) that may be stored in 222 in FIG. 2. In some examples, the size of the circular pattern may be determined empirically or obtained from a training process. For example, different circular pattern sizes may be tested during training, e.g., using cross-validation and/or a validation set. The circular pattern size that yields the lowest angle prediction error may be stored in 222 (FIG. 2) and used during inference. The angle prediction error may be measured using different methods, e.g., L1-norm, L2-norm, classification accuracy, classification F1-score, or any other suitable method that can be used to assess classification performance and/or prediction error.

With further reference to FIG. 4, act 414 may determine the size of the object(s) in the image based on the plurality of feature vectors obtained at act 410. In some embodiments, determining the size of the object may include using a machine learning model (e.g., pose ML model 226 in FIG. 2) and the plurality of feature vectors as input to the machine learning model to determine the size of the object in the image. In some embodiments, the plurality of feature vectors may be concatenated into a single feature vector and provided as input to the machine learning model.

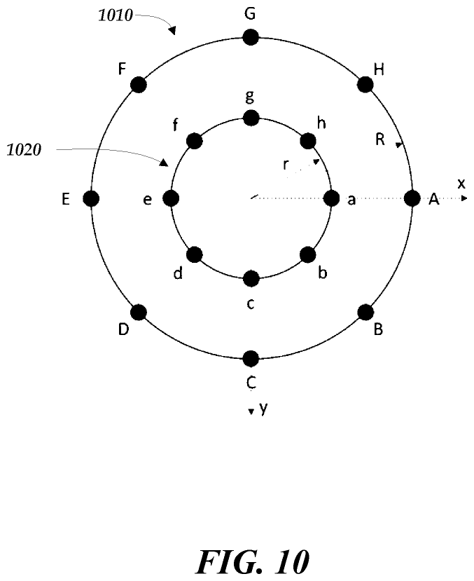

In determining the object size, in some embodiments, a plurality of feature sets may be extracted from the image such that they are each associated with a respective one of a plurality of circular pattern sizes. For example, each of the plurality of feature sets may be extracted from the feature map according to a circular pattern having a respective one of the plurality of circular pattern sizes. As such, multiple concentric circular feature patterns may be used to extract different feature sets from the feature map of the image. The different feature sets may be provided to the machine learning model configured to predict the object size. FIG. 10 illustrates concentric circular patterns 1010, 1020 with different sizes, according to some embodiments of the technologies described herein. As shown, a first circular pattern 1010 with a radius R may be used to extract feature vectors ABCDEFGH; a second circular pattern 1020 with a radius r may be used to extract feature vectors abcdefgh. In a similar manner as described above and further herein, each of the feature vectors ABCDEFGH and abcdefgh may be a concatenated single vector that can be provided as input to the machine learning model.

In some embodiments, the machine learning model (e.g., pose ML model 226 in FIG. 2) may be configured for a plurality of configurations, each trained with a respective circular pattern size. The details of training the machine learning model for predicting object size are further described in embodiments in FIG. 5.

At act 414, in using the machine learning model, a plurality of feature sets are provided to each of a plurality of configurations of the machine learning model. Each of the plurality of feature sets is also associated with a respective circular pattern size. The relation between the different circular feature patterns sizes for the plurality of feature sets may be linear, logarithmic, quadratic, and/or any other function. Each configuration of the plurality of configurations of the machine learning model is associated (trained) with a respective circular pattern size (e.g., a scaling factor). In some embodiments, each configuration of the machine learning model may correspond to a respective classifier. The classifier prediction may be inferred from a feature set extracted according to its corresponding circular feature pattern of the classifier to evaluate the rotation at a scaling factor equal to 1. The classifier prediction may be inferred from a feature set extracted according to a larger circular feature pattern size to evaluate the rotation at a scaling factor larger than 1. The classifier prediction may be inferred from a feature set extracted according to a smaller circular feature pattern size to evaluate the rotation at a scaling factor smaller than 1. These inferences result in multiple combinations of feature sets and configurations of the machine learning models at different of circular pattern sizes, where each combination includes a pair of feature set and a configuration of the machine learning model.

In some embodiments, the object size (e.g., scaling factor) may be inferred from one combination of the multiple combinations, such that the classification probability for that combination is maximized among all other combinations, where the classification probability is generated from the machine learning model. For example, in each of the multiple combinations, a feature set of the plurality of feature sets is applied to a configuration of the machine learning model (e.g., the configuration corresponds to a given circular pattern size) to generate a respective output that includes a rotation angle and associated classification probability.

In some embodiments, the object size may be a scaling factor based on the selected combination (pair of feature vectors and configuration of the machine learning model). The scaling factor s can be expressed

$$s = \frac{{r}_{p}}{{r}_{c}} ,$$

where rₚ is the size (e.g., radius) of the circular feature pattern size (e.g., radius) in the pair that maximizes the classification probability; and r_{c} is the circular feature pattern size associated with the configuration of the machine learning model in the pair.

The operation of act 414 in determining the object size is illustrated with an example shown in FIG. 10. As shown, the smaller circular feature pattern 1020 may be associated with classifier k (a first configuration of the machine learning model). The larger circular feature pattern 1010 may be associated with a classifier K (a second configuration of the machine learning model). In predicting the object size, two feature sets each containing a concatenated feature vector abcdefgh and ABCDEFGH, respectively, are provided to classifier k to generate two outputs each including a respective predicted rotation angle and associated probability for the predicted rotation angle. Similarly, the two feature sets abcdefgh and ABCDEFGH are provided to classifier K to generate two outputs each including a respective predicted rotation angle and associated probability for the predicted rotation angle. This results in four combinations (pairs) of feature vector set and classifier. A combination (pair) is selected that maximizes the classification probability.

In the example above, the predicted object size is determined based on the circular pattern size associated with the classifier and the circular pattern size associated with the feature set in the selected combination. For example, if the selected combination includes classifier k and feature set is ABCDEFGH, then the object size is determined based on the circular pattern size associated with the classifier k (e.g., r) and the circular pattern size associated with feature set ABCDEFGH (e.g., R), such that s=R/r. Similarly, if the selected combination includes classifier K and feature set is abcdefgh, then the object size is determined based on the circular pattern size associated with the classifier K (e.g., R) and the circular pattern size associated with feature set abcdefgh (e.g., r), such that s=r/R. Although the above example is discussed in conjunction with two classifiers (K and k) and two sets of feature vectors, it should be appreciated that the number of sets of feature vectors can be different from the number of classifiers.

With further reference to FIG. 4, method 400 may include determining an object category, at act 408. Determining the object category may allow the system to be trained to detect objects belonging to a given object category, and allow object category specific feature vectors to be extracted. For example, the feature map for objects belonging to different categories may exhibit object category specific features that would allow the system to perform best for a given object category. In some embodiments, in utilizing object category, the machine learning model (e.g., pose ML model 226 in FIG. 2) may include various configurations each trained for a respective object category. In doing this, different sets of training images containing objects belonging to the respective object category may be used. In some embodiments, the feature vectors that are provided to the machine learning model may also be extracted based on the object category. For example, in extracting the feature vectors (e.g., act 410), the circular pattern size may be based at least in part on the object category.

With further reference to FIG. 4, act 408 may be implemented in an object category estimator (e.g., 210 in FIG. 2). In some embodiments, act 408 may use a machine learning model (e.g., object category ML model 224 in FIG. 2) that is trained to predict the object category. Any classifier such as linear, SVM, random forest, or any other classifier may be trained. In some embodiments, feature vectors may be extracted from the feature map of the image at object center(s) and used for predicting the object category. During training, the object category classifier may be trained based on the feature vectors at the ground truth object center. Slight perturbations in object position, object orientation, and/or object size may be used to generate more training examples. These slight perturbations in object position, object orientation, and/or object size may be used to make the object category classifier more robust.

With further reference to FIG. 4, once the object category is predicted at act 408, various operations in method 400 may be performed based on the object category obtained from act 408. For example, the determined object category may be used to select a corresponding classifier (e.g., a corresponding configuration of the machine learning model, such as pose ML model 226 in FIG. 2) via a machine learning configuration selector (e.g., 212 in FIG. 2) such that the configuration of the machine learning model (e.g., pose ML model 226 in FIG. 2) trained for the determined object category is used to detect the pose, including orientation, and/or size of the object(s). Additionally, and/or alternatively, circular pattern sizes that are specific to the object category may be selected via a circular size selector (e.g., circular size selector 211 in FIG. 2) to extract feature vectors (e.g., at act 410) for providing as input to the machine learning model.

With further reference to FIG. 4, method 400 may optionally include refining the pose, including location, orientation, and/or size of the object(s) in the image, at act 416, to determine the final location, orientation, and/or size of the object(s). In some embodiments, act 416 may be implemented in pose refinement unit 240 (FIG. 2).

With further reference to FIG. 4, method 400 may optionally include extracting an object view from the image, at act 418, and performing one or more machine vision operations on the extracted object view, at act 420. In some embodiments, act 418 may be implemented in object view extractor 242 (FIG. 2). The extracted object view from act 418 may include the detected object properly centered, rotated, and/or scaled according to the detected pose (or final pose from refinement, such as act 416). For example, in the extracted object view, the detected object may be centered according to the detected object location, with the orientation angle of the object properly corrected (e.g., de-skewed) according to the detected orientation (e.g., orientation angle and offset), and/or the size of the object properly scaled according to the detected size of the object. The extracted object view and associated object category may be provided to subsequent machine vision application(s) (e.g., 244 in FIG. 2). With the object properly positioned, oriented, scaled, and categorized, the subsequent machine vision applications may achieve a better performance (e.g., accuracy).

In some embodiments, in extracting the object view, an affine transformation may be applied to the input image to extract a view of the object. The affine transformation parameters may be computed based on the object position, orientation, and size to extract a centered, oriented, and scaled view of the object, respectively. The samples in the extracted view may be interpolated from samples in the input view. Different interpolation methods such as nearest neighbor, bilinear, bicubic, or any other interpolation method may be used to interpolate the samples in the extracted view. In some embodiments, the extracted object view may be padded to encompass a margin around the object to account for detection inaccuracies. FIG. 3B shows an extracted object view of the object as shown in FIG. 3A based on the result of object detection as described in embodiments of system 200, according to some embodiments of the technologies described herein.

As described above in embodiments in FIG. 2 and further herein, although FIG. 3A shows a single object in the image, it is appreciated that there may be multiple objects in an image. In such case, the various acts 408-420 may be performed iteratively, where each iteration is performed for a respective one of the multiple objects in the image.

FIG. 5 is a flowchart of an illustrative process for training a machine learning model to be used in detecting objects, according to some embodiments of the technologies described herein. In some embodiments, process 500 may include a method that is implemented in a system such as the system 100 (FIG. 1) and/or the system 200 (e.g., training/re-training system 230) in FIG. 2. Method 500 may include training the machine learning model (e.g., pose ML model 226) or various configurations thereof in FIG. 2. In some embodiments, the pose machine learning model 226 may include any classifier such as a linear classifier, a SVM, a random forest, and/or any other classifier may be trained to predict the object orientation. The classifier may be trained to predict all possible cyclic rotations using training data for a plurality of training objects. For example, the training data may include a set of training images containing training objects. The training data of each object may include an associated plurality of different concatenated set of feature vectors for the object, where each concatenated set of feature vectors stores a plurality of feature vectors for the object in a respective order. As described above and further herein (e.g., FIGS. 6A-6C), the order in which the feature vectors are arranged can encode a respective orientation. Thus, the training data may include perturbations of concatenated sets of feature vectors that each correspond to a different orientation. Additionally, and/or alternatively, the training data may also include perturbations of concatenated sets of feature vectors that each correspond to a different circular pattern size (scaling factor), and/or object location. Perturbations of the sets of feature vectors may be generated as training feature vectors from the training images.

FIG. 9A illustrates a set of feature vectors and a perturbation of the set of feature vectors in orientation and position, according to some embodiments of the technologies described herein. As shown, the set of feature vectors A′B′C′D′E′F′G′H′ may be a perturbation that has a slight orientation offset a (clockwise) from the orientation of set of feature vectors ABCDEFGH. It is also shown that the center pl of the set of feature vectors A′B′C′D′E′F′G′H′ has a slight position offset d from the center position p0 of the set of feature vectors ABCDEFGH. In a similar manner, training sets of feature vectors may be generated where each set of feature vectors corresponds to a respective circular pattern size, such as shown in FIG. 10. In FIG. 10, the set of feature vectors ABCDEFGH correspond to a circular pattern 1010 having a size R and the set of feature vectors abcdefgh correspond to a circular pattern 1020 having a size r.

As described above and further herein, the perturbations of the circular patterns in orientation, position, and/or size may be used to generate training data from the training images. It is appreciated that a large number of perturbations of feature vectors may be generated from each training image, which results in a low requirement on the number of training images that need to be collected. It is further appreciated that certain perturbations of feature vectors do not require extracting feature vectors from the training image. For example, with 8 feature vectors having locations arranged in a circular pattern, a perturbation of 45 degree rotation will only need to re-order the extracted feature vectors at zero-degree rotation without extracting additional feature vectors from the training image. In view of the foregoing, the training process for training the machine learning model (e.g., pose ML model 226 in FIG. 2) requires low requirement on collecting training images and low computational resources on generating the training data, making it suitable for training the machine learning model in the field.

Returning to FIG. 5, method 500 may start with obtaining training images, at act 502. In some embodiments, training images having objects(s) may be collected with an image capturing device configured to take images of the object(s). For example, the system as described in embodiments in FIG. 1 may be used to collect training images using the image capturing device 112. Method 500 may further include obtaining ground truth data at act 504. In some embodiments, the ground truth data may include a bounding box for each object in the training images, where the bounding box indicates the location, orientation, and/or size of the object. As shown in FIG. 3A, a ground truth bounding box 302 is overlaid on the object (e.g., a printed circuit board) in the training image.

With further reference to FIG. 5, method 500 may further include generate training data from the training images at act 506. In some embodiments, generating training data may include extracting sets of feature vectors from the training images, where the sets of feature vectors include perturbations in object location, object orientation, and/or object size as described above and further herein. Method 500 may further include training the machine learning model using the extracted feature vectors, at act 508.

In some embodiments, the machine learning model (e.g., pose ML model 226 in FIG. 2) may include a plurality of configurations each trained with a respective set of training data. For example, a configuration of the machine learning model may be viewed as an instance of the machine learning model with a respective set of parameters that are trained with a set of training data. Each set of training data may correspond to a particular circular pattern size, a particular object category, or a combination thereof. For example, a set of training data is collected from training images containing a specific object category, and used to train a configuration of the machine learning model that is associated with that specific object category. Training data for another object category may be used to train another configuration of the machine learning model associated with the another object category. Similarly, each configuration of the machine learning model may be trained solely from the training feature vectors extracted from its corresponding circular pattern, e.g., at a given size, where the circular patterns may be scaled according to the ground truth object size (e.g., bounding box of the object).

As described above and further herein, during inference, the system may select a configuration of the machine learning model (e.g., via machine learning configuration selector 212 in FIG. 2) depending on the prediction tasks at the pose estimator (e.g., 208 in FIG. 2). For example, when object category estimator (210 in FIG. 2) is used, the feature vector extractor (206 in FIG. 2) may extract feature vectors for the estimated object category and provide the extracted feature vectors to the pose estimator (208 in FIG. 2). In another example, when estimating the object size (described in embodiments in FIG. 4, such as act 414), a plurality of configurations of the machine learning model (e.g., pose ML model 226 in FIG. 2) associated with various sizes are used with a plurality of sets of feature vectors corresponding to different circular pattern sizes. The predicted object size is determined based on the plurality of outputs from the plurality of the configurations of the machine learning model, as described in details in embodiments of FIG. 4.

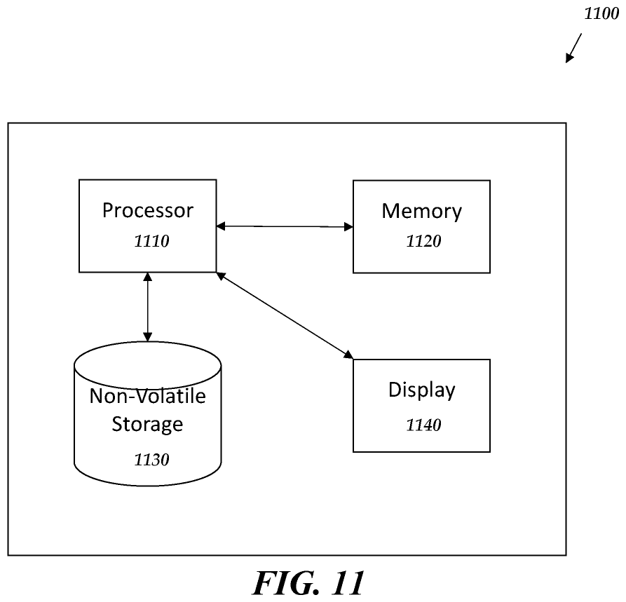

An illustrative implementation of a computer system 1100 that may be used to perform any of the aspects of the techniques and embodiments disclosed herein is shown in FIG. 11. In some embodiments, the computer system 1100 may be installed in system 100 of FIG. 1, such as by server 110. The computer system 1100 may be configured to perform various methods and acts as described with respect to FIGS. 1-10. The computer system 1100 may include one or more processors 1110 and one or more non-transitory computer-readable storage media (e.g., memory 1120 and one or more non-volatile storage media 1130) and a display 1140. The processor 1110 may control writing data to and reading data from the memory 1120 and the non-volatile storage device 1130 in any suitable manner, as the aspects of the invention described herein are not limited in this respect. To perform functionality and/or techniques described herein, the processor 1110 may execute one or more instructions stored in one or more computer-readable storage media (e.g., the memory 1120, storage media, etc.), which may serve as non-transitory computer-readable storage media storing instructions for execution by the processor 1110.

In connection with techniques described herein, code used to, for example, detect objects in images/videos may be stored on one or more computer-readable storage media of computer system 1100. Processor 1110 may execute any such code to provide any techniques for detecting objects as described herein. Any other software, programs or instructions described herein may also be stored and executed by computer system 1100. It will be appreciated that computer code may be applied to any aspects of methods and techniques described herein. For example, computer code may be applied to interact with an operating system to detect objects through conventional operating system processes.

The various methods or processes outlined herein may be coded as software that is executable on one or more processors that employ any one of a variety of operating systems or platforms. Additionally, such software may be written using any of numerous suitable programming languages and/or programming or scripting tools, and also may be compiled as executable machine language code or intermediate code that is executed on a virtual machine or a suitable framework.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program,” “software,” and/or “application” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in non-transitory computer-readable storage media in any suitable form. Data structures may have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various inventive concepts may be embodied as one or more methods, of which examples have been provided. The acts performed as part of a method may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This allows elements to optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

Various aspects are described in this disclosure, which include, but are not limited to, the following aspects:
1. A computerized method for detecting an object in an image, the method comprising: accessing a feature map of the image, wherein the feature map was generated using a pre-trained machine learning model and the image as input to the pre-trained machine learning model, the feature map including a plurality of samples that are each associated with a respective feature vector; extracting a plurality of feature vectors from the feature map at respective locations on the feature map, wherein the respective locations are arranged around a circular pattern; and determining an orientation of the object in the image based on the plurality of feature vectors.
2. The method of aspect 1, wherein the respective locations of the plurality of feature vectors are equally spaced and arranged around the circular pattern.
3. The method of aspect 1 or any other aspect, further comprising: determining a location of the object in the image; wherein the circular pattern is centered around the location of the object in the image.
4. The method of aspect 3 or any other aspect, wherein determining the location of the object in the image comprises: processing the feature map of the image using the pre-trained machine learning model to generate an object center heatmap for the image, wherein the object center heatmap comprises a plurality of samples each having a value indicative of a likelihood of a corresponding sample in the image being a center of an object; and determining the location of the object in the image based on the object center heatmap.
5. The method of aspect 3 or any other aspect, wherein: the pre-trained machine learning model is a first machine learning model; and determining the orientation of the object in the image comprises using a second machine learning model and the plurality of feature vectors as inputs to the second machine learning model to determine the orientation of the object in the image.
6. The method of aspect 5 or any other aspect, wherein the plurality of feature vectors are stored as a concatenated set of feature vectors in an order based on the circular pattern.
7. The method of aspect 6 or any other aspect, wherein: the second machine learning model was trained using training data for a plurality of training objects; and the training data of each object of the plurality of training objects comprises an associated plurality of different concatenated set of feature vectors for the object, wherein each concatenated set of feature vectors stores a plurality of feature vectors for the object in a respective order based on the circular pattern that is different than the order of the remaining plurality of concatenated feature vectors for the object.
8. The method of aspect 5 or any other aspect, wherein determining the orientation of the object in the image comprises using the second machine learning model to determine a rotation angle of the object.
9. The method of aspect 8 or any other aspect, further comprising: using the second machine learning model to determine a rotation offset of the object; and determining the orientation of the object in the image based on the rotation angle and the rotation offset of the object.
10. The method of aspect 9 or any other aspect, wherein determining the rotation offset of the object comprises: for each of a plurality of rotation offsets, using the second machine learning model to generate a respective orientation and an associated classification probability; selecting the rotation offset from the plurality of rotation offsets, wherein the selected rotation offset has a maximum classification probability among the classification probabilities for the plurality of rotation offsets.
11. The method of aspect 5 or any other aspect, wherein: the second machine learning model was trained using training data for a plurality of training objects; and the training data of each object of the plurality of training objects comprises: a first concatenated set of feature vectors for the object that stores a first plurality of feature vectors at first locations arranged around the circular pattern; and a second concatenated set of feature vectors for the object that stores a second plurality of feature vectors at second locations arranged around the circular pattern that are different than the first locations.
12. The method of aspect 11 or any other aspect, wherein the first locations and the second locations around the circular pattern are arranged to represent different orientations.
13. The method of aspect 11 or any other aspect, wherein the first locations and the second locations around the circular pattern are arranged to represent different scaling factors.
14. The method of aspect 5 or any other aspect, wherein the circular pattern has a size predetermined based on a training process.
15. The method of aspect 5 or any other aspect, further comprising: determining an object category of a plurality of object categories for the object; wherein: the second machine learning model comprises a plurality of configurations each trained to be associated with a respective different one of the plurality of object categories; and the respective locations of the plurality of feature vectors are based on the determined object category.
16. The method of aspect 15 or any other aspect, wherein determining the object category comprises: extracting a category feature from the feature map; and using a third machine learning model and the category feature as input to the third machine learning model to determine the object category.
17. The method of aspect 16 or any other aspect, wherein the category feature includes at least a feature from the feature map at the location of the object in the image.
18. The method of aspect 5 or any other aspect, further comprising determining a size of the object by: extracting a plurality of feature sets, each set (a) associated with a respective one of a plurality of circular pattern sizes and (b) extracted from the feature map according to a circular pattern having a respective one of the plurality of circular pattern sizes; using the second machine learning model and the plurality of feature sets as input to the second machine learning model, to generate a plurality of outputs; and determining the size of the object based on the plurality of outputs from the second machine learning model.
19. The method of aspect 18 or any other aspect, wherein: each of the plurality of outputs (a) is associated with a respective one of a plurality of configurations of the second machine learning model, each configuration is trained for a respective one of the plurality of training circular pattern sizes; and (b) comprises a plurality of classification probabilities that are each associated with a respective one of the plurality of feature sets provided as input to the second machine learning model; and determining the size of the object comprises: determining a respective scaling factor for each one of the plurality of configurations of the second machine learning model based on the output associated with the configuration of the plurality of configurations of the second machine learning model; and determining the size of the object based on the scale factors and the plurality of classification probabilities associated with each of the plurality of configurations of the second machine learning model.
20. The method of aspect 19 or any other aspect, wherein determining the size of the object based on the scale factors and the plurality of classification probabilities associated with each of the plurality of configurations of the second machine learning model comprises: determining a pair of one of the plurality of configurations of the second machine learning model and one of the plurality of feature sets which maximize probabilities among all combinations of pairs of the plurality of configurations of the second machine learning model and the plurality of feature sets; and determining the size of the object based on the associated training circular pattern size of the one of the plurality of configurations of the second machine learning model and the associated circular pattern size of the one of the plurality of feature sets in the pair.
21. The method of aspect 5 or any other aspect, wherein: the second machine learning model was trained at a different site from the pre-trained machine learning model, or the second machine learning model was trained using only one training image or a few training images.
22. The method of aspect 5 or any other aspect, wherein the second machine learning model was trained after the pre-trained machine learning model.
23. The method of aspect 5 or any other aspect, further comprising: before determining the location of the object, training the second machine learning model using training data for a plurality of training objects.
24. The method of aspect 23 or any other aspect, wherein training the second machine learning model comprises field training the second machine learning model using a low computing power device.
25. The method of aspect 5 or any other aspect, wherein the second machine learning model was field trained using a low computing power device.
26. The method of aspect 5 or any other aspect, wherein the second machine learning model is a non-deep learning model.
27. The method of aspect 1 or any other aspect, further comprising detecting a set of additional objects in the image by: for each additional object of the set: extracting a respective plurality of feature vectors from the feature map at respective locations on the feature map, wherein the respective locations are arranged around an associated circular pattern based on an associated location of the additional object in the image; and determining a respective orientation of the additional object in the image based on the respective plurality of feature vectors.
28. The method of aspect 1 or any other aspect, wherein the respective locations are arranged around one or more circular patterns, and wherein the determining comprises determining orientations of objects of a plurality of objects based on the plurality of feature vectors.
29. The method of aspect 28 or any other aspect, further comprising: determining a location of objects of the plurality of objects in the image; wherein the one or more circular patterns are centered around the locations of the objects in the image.
30. A system comprising at least one processor configured to perform one or more operations in any of aspects 1-29.
31. A non-transitory computer readable medium comprising program instructions that, when executed, cause at least one processor to perform one or more operations in any of aspects 1-29.

1. A computerized method for detecting an object in an image, the method comprising:
accessing a feature map of the image, wherein the feature map was generated using a pre-trained machine learning model and the image as input to the pre-trained machine learning model, the feature map including a plurality of samples that are each associated with a respective feature vector;
extracting a plurality of feature vectors from the feature map at respective locations on the feature map, wherein the respective locations are arranged around a circular pattern; and
determining an orientation of the object in the image based on the plurality of feature vectors.

2. The method of claim 1, wherein the respective locations of the plurality of feature vectors are equally spaced and arranged around the circular pattern.

3. The method of claim 1, further comprising:
determining a location of the object in the image;
wherein the circular pattern is centered around the location of the object in the image.

4. The method of claim 3, wherein determining the location of the object in the image comprises:
processing the feature map of the image using the pre-trained machine learning model to generate an object center heatmap for the image, wherein the object center heatmap comprises a plurality of samples each having a value indicative of a likelihood of a corresponding sample in the image being a center of an object; and
determining the location of the object in the image based on the object center heatmap.

5. The method of claim 3, wherein:
the pre-trained machine learning model is a first machine learning model; and
determining the orientation of the object in the image comprises using a second machine learning model and the plurality of feature vectors as inputs to the second machine learning model to determine the orientation of the object in the image.

6. The method of claim 5, wherein the plurality of feature vectors are stored as a concatenated set of feature vectors in an order based on the circular pattern.

7. The method of claim 6, wherein:
the second machine learning model was trained using training data for a plurality of training objects; and
the training data of each object of the plurality of training objects comprises an associated plurality of different concatenated set of feature vectors for the object, wherein each concatenated set of feature vectors stores a plurality of feature vectors for the object in a respective order based on the circular pattern that is different than the order of the remaining plurality of concatenated feature vectors for the object.

8. The method of claim 5, wherein determining the orientation of the object in the image comprises using the second machine learning model to determine a rotation angle of the object.

9. The method of claim 8, further comprising:
using the second machine learning model to determine a rotation offset of the object; and
determining the orientation of the object in the image based on the rotation angle and the rotation offset of the object.

10. The method of claim 9, wherein determining the rotation offset of the object comprises:
for each of a plurality of rotation offsets, using the second machine learning model to generate a respective orientation and an associated classification probability;
selecting the rotation offset from the plurality of rotation offsets, wherein the selected rotation offset has a maximum classification probability among the classification probabilities for the plurality of rotation offsets.

11. The method of claim 5, wherein:
the second machine learning model was trained using training data for a plurality of training objects; and
the training data of each object of the plurality of training objects comprises:
a first concatenated set of feature vectors for the object that stores a first plurality of feature vectors at first locations arranged around the circular pattern; and
a second concatenated set of feature vectors for the object that stores a second plurality of feature vectors at second locations arranged around the circular pattern that are different than the first locations.

12.-14. (canceled)

15. The method of claim 5, further comprising:
determining an object category of a plurality of object categories for the object;
wherein:
the second machine learning model comprises a plurality of configurations each trained to be associated with a respective different one of the plurality of object categories; and
the respective locations of the plurality of feature vectors are based on the determined object category.

16. The method of claim 15, wherein determining the object category comprises:
extracting a category feature from the feature map; and
using a third machine learning model and the category feature as input to the third machine learning model to determine the object category.

17. (canceled)

18. The method of claim 5, further comprising determining a size of the object by:
extracting a plurality of feature sets, each set (a) associated with a respective one of a plurality of circular pattern sizes and (b) extracted from the feature map according to a circular pattern having a respective one of the plurality of circular pattern sizes;
using the second machine learning model and the plurality of feature sets as input to the second machine learning model, to generate a plurality of outputs; and
determining the size of the object based on the plurality of outputs from the second machine learning model.

19. The method of claim 18, wherein:
each of the plurality of outputs (a) is associated with a respective one of a plurality of configurations of the second machine learning model, each configuration is trained for a respective one of the plurality of training circular pattern sizes; and (b) comprises a plurality of classification probabilities that are each associated with a respective one of the plurality of feature sets provided as input to the second machine learning model; and
determining the size of the object comprises:
determining a respective scaling factor for each one of the plurality of configurations of the second machine learning model based on the output associated with the configuration of the plurality of configurations of the second machine learning model; and
determining the size of the object based on the scale factors and the plurality of classification probabilities associated with each of the plurality of configurations of the second machine learning model.

20. The method of claim 19, wherein determining the size of the object based on the scale factors and the plurality of classification probabilities associated with each of the plurality of configurations of the second machine learning model comprises:
determining a pair of one of the plurality of configurations of the second machine learning model and one of the plurality of feature sets which maximize probabilities among all combinations of pairs of the plurality of configurations of the second machine learning model and the plurality of feature sets; and
determining the size of the object based on the associated training circular pattern size of the one of the plurality of configurations of the second machine learning model and the associated circular pattern size of the one of the plurality of feature sets in the pair.

21.-26. (canceled)

27. The method of claim 1, further comprising detecting a set of additional objects in the image by:
for each additional object of the set:
extracting a respective plurality of feature vectors from the feature map at respective locations on the feature map, wherein the respective locations are arranged around an associated circular pattern based on an associated location of the additional object in the image; and
determining a respective orientation of the additional object in the image based on the respective plurality of feature vectors.

28. The method of claim 1, wherein the respective locations are arranged around one or more circular patterns, and wherein the determining comprises determining orientations of objects of a plurality of objects based on the plurality of feature vectors.

29. (canceled)

30. A system comprising at least one processor configured to detect an object in an image by performing:
accessing a feature map of the image, wherein the feature map was generated using a pre-trained machine learning model and the image as input to the pre-trained machine learning model, the feature map including a plurality of samples that are each associated with a respective feature vector;
extracting a plurality of feature vectors from the feature map at respective locations on the feature map, wherein the respective locations are arranged around a circular pattern; and
determining an orientation of the object in the image based on the plurality of feature vectors.

31. A non-transitory computer readable medium comprising program instructions that, when executed, cause at least one processor to detect an object in an image by performing:
accessing a feature map of the image, wherein the feature map was generated using a pre-trained machine learning model and the image as input to the pre-trained machine learning model, the feature map including a plurality of samples that are each associated with a respective feature vector;
extracting a plurality of feature vectors from the feature map at respective locations on the feature map, wherein the respective locations are arranged around a circular pattern; and
determining an orientation of the object in the image based on the plurality of feature vectors.
